(19) United States
(12) Patent Application Publication
(10) Pub. No.: US 2002/0038274 A1
(43) Pub. Date: Mar. 28, 2002

(54) Commodity information retrieval system

(75) Inventor: Yuji Takei, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/956,822

(22) Filed: Sep. 21, 2001

(30) Foreign Application Priority Data
Sep. 27, 2000 (JP) 2000-293680

(51) Int. Cl. G06F 17/60

(52) U.S. Cl. 705/36

(57) ABSTRACT

A commodity information retrieval system includes a commodity information server for responding to a retrieval request specifying the commodity which a user wishes to buy, the user address or the area at which the user wishes to buy the commodity and a priority item of the user in buying the commodity. The priority specified for selecting the shop is either the selling price, the time length for the traffic access and the cost of the traffic access. A list of recommended shops including information of the selling price, and the time length and the cost for the traffic access is transferred from the commodity information server to the user terminal.

### BACKGROUND OF THE INVENTION

(a) Field of the Invention

The present invention relates to a commodity information retrieval system and, more particularly, to a commodity information retrieval system for retrieving commodity information including shop name, selling price, shop location etc. through a communication network.

(b) Description of the Related Art

For a user to retrieve commodity information through a communication network from the user terminal, there is a method including the steps of accessing through the Internet a homepage of a shopping server, and inputting the item or a trade mark of the commodity, which the user wishes to buy, to thereby obtain the shop name selling the commodity and the selling price of the commodity.

However, the method as described above does not enable the user to know the shop name or selling price of the commodity in the specified area where the user wishes to buy the commodity or to which the user has an easy traffic access from his home. This causes disadvantages in that the user often goes to a distant shop to buy the commodity only at a slightly lower price, or user often buys a commodity at a higher price although the commodity is in fact soled at a lower price in the area which is located at a slightly distant location, resulting in the waste of time or cost.

### SUMMARY OF THE INVENTION

In view of the above, it is an object of the present invention to provide a commodity retrieval system which enables the user to know the selling prices and the shops selling the commodity, that he wishes to buy, in the area where he wishes to buy the commodity or where he has an easy traffic access from his home.

The present invention provides, in a first aspect thereof, a commodity information retrieval system including a commodity information server connected to a plurality of user terminals through a communication network, the commodity information server including:

a commodity information data base for storing commodity information relating to a plurality of commodities, the commodity information including a plurality of shops each selling the commodities, selling prices of the commodities in the respective shops and locations of the respective shops;

a tabulating section for retrieving information from the commodity information data base in response to a retrieval request from one of the user terminals to thereby form a list of recommended shops, the retrieval request specifying at least one commodity and an area at which the at least one commodity is to be bought, the list of recommended shops including information of selling prices of the at least one commodity in respective the recommended shops and locations of the recommended shops; and

a transferring section for transferring the list of recommended shops to the one of the user terminals.

The present invention provides, in a second aspect thereof, a commodity information retrieval system including a commodity information server connected to a plurality of user terminals through a communication network, the commodity information server including:

a commodity information data base for storing commodity information relating to a plurality of commodities, the commodity information including a plurality of shops each selling the commodities, selling prices of the commodities in the respective shops and locations of the respective shops;

a tabulating section for retrieving information from the commodity information data base in response to a retrieval request from one of the user terminals to thereby form a list of recommended shops, the retrieval request specifying at least one commodity and a user address, the list of recommended shops including information of selling prices of the at least one commodity in respective the recommended shops and locations of the recommended shops; and

a transferring section for transferring the list of recommended shops to the one of the user terminals.

The above and other objects, features and advantages of the present invention will be more apparent from the following description, referring to the accompanying drawings.

### BRIEF DESCRIPTION OF THE DRAWINGS

FIG. 1 is a block diagram of a commodity information retrieval system according to an embodiment of the present invention.

FIG. 2 is a block diagram of the commodity information data base shown in FIG. 1.

FIG. 3 is a flowchart showing the procedure in the commodity information retrieval system of FIG. 1.

FIG. 4 is a front view of the screen showing the input items in the user terminal shown in FIG. 1.

FIG. 5 is a front view of the screen showing the retrieved commodity information in the user terminal shown in FIG. 1.

### PREFERRED EMBODIMENT OF THE INVENTION

Now, the present invention is more specifically described with reference to accompanying drawings, wherein similar constituent elements are designated by similar reference numerals.

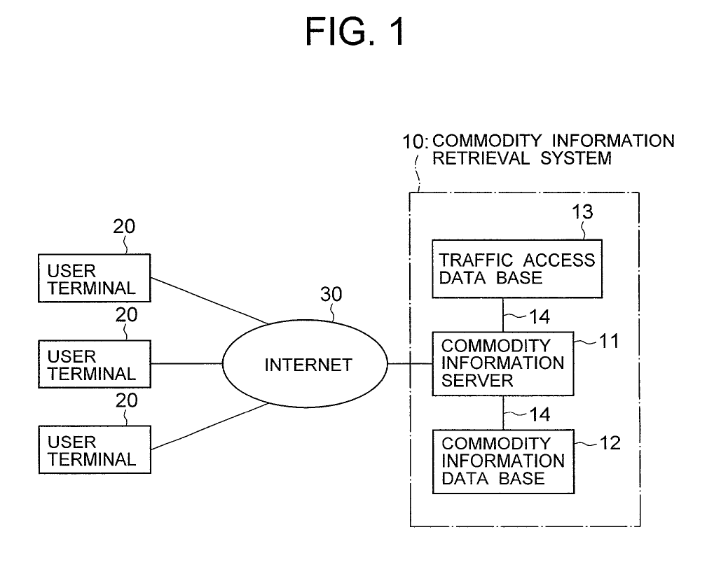

Referring to FIG. 1, a commodity information retrieval system 10 according to an embodiment of the present invention has a commodity information server 11 including a server computer and peripheral devices (not shown) such as storage devices and a display panel, a commodity information data base 12 and a traffic access data base 13 both of which are connected to the commodity information server 11 via bus lines 14. The commodity information system 10 is connected to a plurality of user terminals 20 through a network 30 such as the Internet. The user terminals 20 are preferably personal computers owned by users or clients.

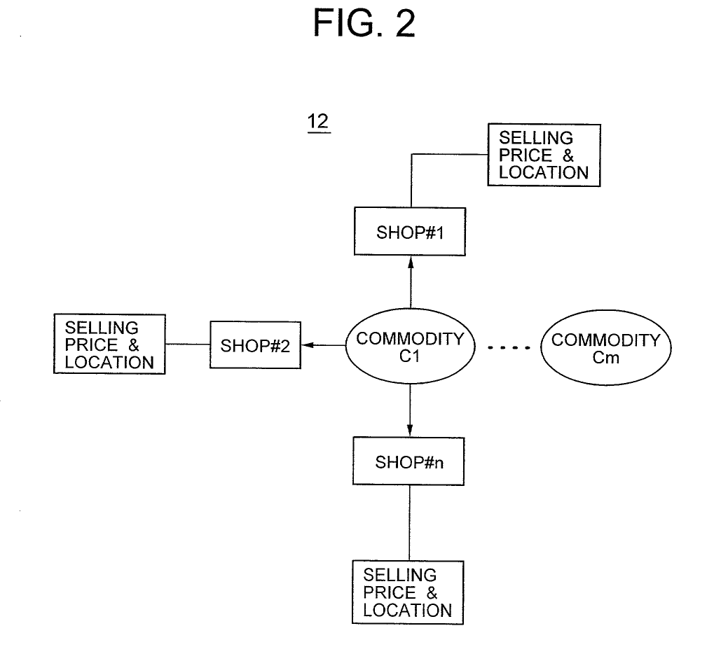

Referring to FIG. 2, the commodity data base 12 stores information for a plurality of commodities C1 to Cm. The information for each of the commodities C1 to Cm includes information of a plurality (“n”, for example) of shops selling the each commodity, a plurality of selling prices of the each commodity in the respective shops, and the locational information for the respective shops.

The traffic access data base 13 stores traffic access information relating to the traffic means and the routes for reaching to the shops. An example of the traffic access information includes information of the nearby station, timetable of the nearby station, the route number or road name from the nearby station to the shop and the distance or time length therebetween. The data to be stored in the traffic access data base 13 may be downloaded from an existing traffic access data base server.

The commodity information server 11 includes a tabulator or tabulating section for preparing a list of recommended shops in response to the retrieval request transferred from a user terminal 20 specifying the commodity item. The recommended shops are extracted from the commodity information data base 12 with reference to the traffic access data base 13 mainly based on the distance between the user address and the location of the shop. The list of recommended shops includes information for the selling prices, shop names, location of the shops and traffic access means from the user's home to the shop. The commodity information server 11 also includes a transmission section for transmitting the information for the list of the recommended shops to the user terminal which transferred the retrieval request.

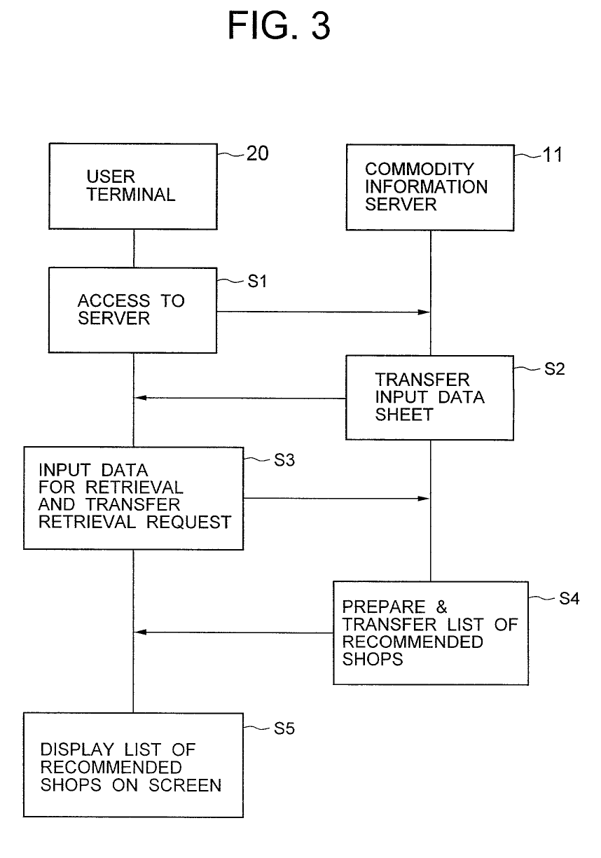

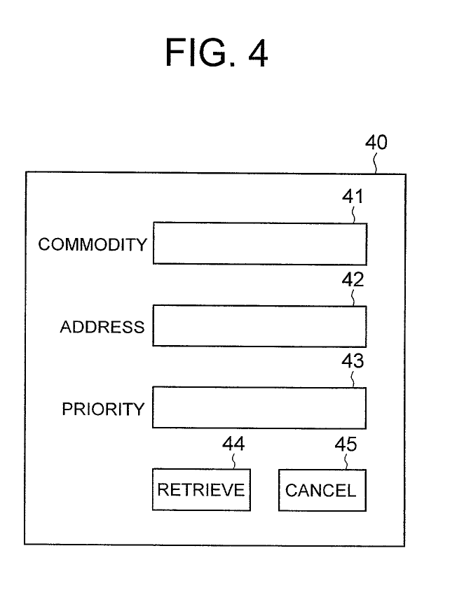

Referring to FIG. 3, there is shown a flowchart for showing the procedure of the retrieval by the commodity retrieval system of FIG. 1. The user terminal 20 first accesses the commodity information server 11 via the Internet (step S1). The commodity information server 11 then transfers HTML data for an input data sheet having input boxes and buttons such as shown in FIG. 4 (step S2). More specifically, in FIG. 4, the image data 40 on the screen include boxes 41 to 43 for inputting therein a commodity item, the user address and a priority item, respectively, as well as click buttons 44 and 45 for the transmission of the retrieval request and cancel of the retrieval request, respectively.

The user may be invited to input the commodity code, trade mark, category, maker of the commodity etc., in addition to or instead of the commodity, in the box 41 for the commodity. The user is also invited to input the user address in the box 42 for the address, and to input the priority item, with which the user wishes to select the shop, in the box 43 for the priority. The priority item is selected by the user from the items including selling price of the commodity, time length needed for the traffic access (transportation time) from the user address to the shop, and the traffic cost needed for the traffic access (transportation cost).

If the selling price is selected as the priority item, then recommended shops are arranged in the ascending order of the selling price of the commodity. Similarly, if the transportation time is selected as the priority item, then recommended shops are arranged in the ascending order of the transportation time; and if the transportation cost is selected, then recommended shops are arranged in the ascending order of the transportation cost. The key inputs in the user terminal may be guided by a pull-down menu on the screen. The traffic means from the user address to the shop may be selected by the user in the retrieval request specifying one of train, car and walk.

After the user fill the boxes 41 to 43 and click the retrieval request button 44 (step S3), a retrieval request is transferred from the user terminal to the commodity information server, the retrieval request including information of commodity item, user address and priority item.

The commodity information server 11, after receiving the retrieval request through the Internet from the user terminal 20, extracts commodity information based on the commodity item, user address and priority item specified in the retrieval request from the commodity information data base and the traffic access data base. Thus, a list of the recommended shops which are located near the user address is prepared. The commodity information server 11 then transfers data for the list of the recommended shops to the user terminal through the Internet (step S4).

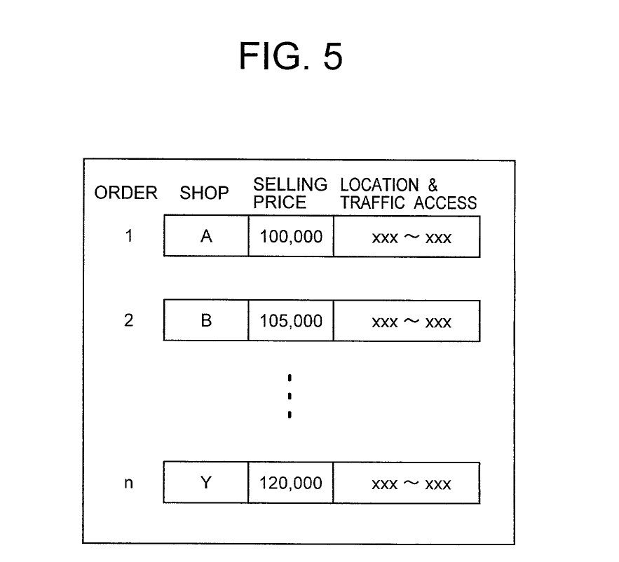

The user terminal 20 displays the list of the recommended shops on the screen of the display unit based on the transferred data (step S5). FIG. 5 shows an example of the list of the recommended shops, which are arranged in an ascending order of the selling price based on the priority item in the retrieval request which specifies “selling price”. In the list, first through fourth columns show the orders in the list, shop names, selling prices and location/traffic means, respectively. The shop names in the list are associated with the selling prices, and the locations and the traffic means including the time length needed from the user address to the shop. The information of the traffic means may be such as “Subway Ginza Line, get off at Ginza Station, and total of fifteen minutes from the user address”, or “Drive on Route No. 246 to the west, and eighteen minutes from the user address”, or “Walk on Route No. 246 to the west, and five minutes from the user address”.

By inspecting the list of the recommended shops, the user can find the shop that sells the commodity in the area in which he wishes to buy or to which he has an easy traffic access, as well as at the reasonable selling price of the commodity. He also conveniently knows the traffic access to the shop.

The commodity information data base may include, in addition to the information of shop name, selling price and location of the shop, as described above, other information such as the number of commodity stock in the shop, presence or absence of guarantee for the commodity by the shop, after-service system of the shop etc. This additional information may be incorporated in the list of the recommended shops.

Since the above embodiment is described only for an example, the present invention is not limited to the above embodiment and various modifications or alterations can be easily made therefrom by those skilled in the art without departing from the scope of the present invention.

What is claimed is:

1. A commodity information retrieval system comprising a commodity information server connected to a plurality of user terminals through a communication network, said commodity information server including:
a commodity information data base for storing commodity information relating to a plurality of commodities, said commodity information including a plurality of shops each selling said commodities, selling prices of said commodities in said respective shops and locations of said respective shops;
a tabulating section for retrieving information from said commodity information data base in response to a retrieval request from one of said user terminals to thereby form a list of recommended shops, said retrieval request specifying at least one commodity and an area at which said at least one commodity is to be bought, said list of recommended shops including information of selling prices of said at least one commodity in respective said recommended shops and locations of said recommended shops; and
a transferring section for transferring said list of recommended shops to said one of said user terminals.

2. The commodity information retrieval system as defined in claim 1, wherein said retrieval request includes information of a priority item specifying a selling-price priority for said at least one commodity, a time-length priority for a traffic access or a cost priority for said traffic access, and said list of recommended shops tabulates recommended shops in an order specified by said specified priority.

3. A commodity information retrieval system comprising a commodity information server connected to a plurality of user terminals through a communication network, said commodity information server including:
a commodity information data base for storing commodity information relating to a plurality of commodities, said commodity information including a plurality of shops each selling said commodities, selling prices of said commodities in said respective shops and locations of said respective shops;
a tabulating section for retrieving information from said commodity information data base in response to a retrieval request from one of said user terminals to thereby form a list of recommended shops, said retrieval request specifying at least one commodity and a user address, said list of recommended shops including information of selling prices of said at least one commodity in respective said recommended shops and locations of said recommended shops; and
a transferring section for transferring said list of recommended shops to said one of said user terminals.

4. The commodity information retrieval system as defined in claim 3, wherein said commodity information server further includes a traffic access data base for storing information relating to traffic accesses to said shops stored in said commodity information data base.

5. The commodity information retrieval system as defined in claim 4, wherein said retrieval request further specifies an area at which said at least one commodity is to be bought.

6. The commodity information retrieval system as defined in claim 4, wherein said retrieval request includes a priority item specifying a selling-price priority for said at least one commodity, a time-length priority for a traffic access or a cost priority for said traffic access, and said list of recommended shops tabulates recommended shops in an order specified by said specified priority.
